(19) United States
(12) Patent Application Publication
(10) Pub. No.: US 2014/0348364 A1
(43) Pub. Date: Nov. 27, 2014

(54) AUGMENTED REALITY MULTISENSORY DISPLAY DEVICE INCORPORATED WITH HEARING ASSISTANCE DEVICE FEATURES

(71) Applicant: Starkey Laboratories, Inc., Eden Prairie, MN (US)

(72) Inventor: Brent Edwards, San Francisco, CA (US)

(73) Assignee: Starkey Laboratories, Inc., Eden Prairie, MN (US)

(21) Appl. No.: 14/285,210

(22) Filed: May 22, 2014

Related U.S. Application Data
(60) Provisional application No. 61/826,483, filed on May 22, 2013.

(51) Int. Cl. G02C 11/06; H04R 25/00; G02B 27/01; G02C 11/00

(52) U.S. Cl. CPC G02C 11/06; G02C 11/10; H04R 25/604; G02B 27/017
USPC 381/327

(57) ABSTRACT

The present subject matter includes reality multisensory display device (MSD) to be used by a wearer having an ear. The device includes a head-mounted display, display circuitry configured to provide signals to the head-mounted display, audio circuitry configured to augment audio delivered to the wearer, and a receiver configured to be worn in or on the ear of the wearer and to play audio to the wearer. In various embodiments, a cable assembly is configured to connect the receiver to the audio circuitry.

### CLAIM OF PRIORITY AND INCORPORATION BY REFERENCE

The present application claims the benefit under 35 U.S.C. §119(e) of U.S. Provisional Patent Application 61/826,483, filed May 22, 2013, the disclosure of which is hereby incorporated by reference herein in its entirety.

### TECHNICAL FIELD

This document relates generally to multisensory display devices and hearing assistance systems.

### BACKGROUND

Multisensory display devices (MSDs) provide visual and auditory information to a wearer. Some MSDs, such as GOOGLE GLASS, have bone conduction speakers/transducers to provide audio to the wearer of the MSD. There are many drawbacks to this, including poor sound quality due to the bandpass nature of sound conducted through the skull, and poor spatial perception due to distortion of binaural cues necessary for spatial hearing.

Thus, there is a need in the art for methods and apparatus to provide improved auditory information for the wearer of MSDs.

### SUMMARY

Disclosed herein, among other things, are systems and methods for augmented MSDs. One aspect of the present subject matter includes an MSD including a head-mounted display, display circuitry configured to provide signals to the head-mounted display, audio circuitry configured to augment audio delivered to the wearer, and a receiver configured to be worn in or on the ear of the wearer and to play audio to the wearer. In various embodiments, a cable assembly is configured to connect the receiver to the audio circuitry.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 illustrates a multisensory display device (MSD) with a receiver-in-canal (RIC) hearing assistance device, according to various embodiments of the present subject matter.

FIG. 2 illustrates a block diagram of a system including a hearing assistance device with cable assembly and an MSD, according to various embodiments of the present subject matter.

FIG. 3 illustrates a block diagram of a system including a wireless hearing assistance device and an MSD, according to various embodiments of the present subject matter.

FIG. 4 illustrates a block diagram of a wireless communication system for the wireless hearing assistance device and MSD of FIG. 3, according to various embodiments of the present subject matter.

FIG. 5 illustrates an MSD with a behind-the-ear (BTE) hearing assistance device, according to various embodiments of the present subject matter.

FIGS. 6A-6B illustrate an MSD with hearing aid circuitry, according to various embodiments of the present subject matter.

FIG. 7 illustrates a wireless communication system for a wireless hearing assistance device and an MSD, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled. The present disclosure relates to augmented reality multisensory display devices (MSDs), such as GOOGLE GLASS, which provide visual and auditory information to the wearer of the device beyond what they normally would see or hear without the device. In various examples, this sensory information includes an augmentation of the environment around the wearer (visually or aurally displaying identification of objects around the wearer after object identification, such as a user's name when the face is identified). In various examples, the sensory information may be unrelated to the environment, such as providing an incoming text message visually or aurally. In various applications, combinations of sensory information augmenting the wearer's environment and sensory information unrelated to the environment are provided to the wearer.

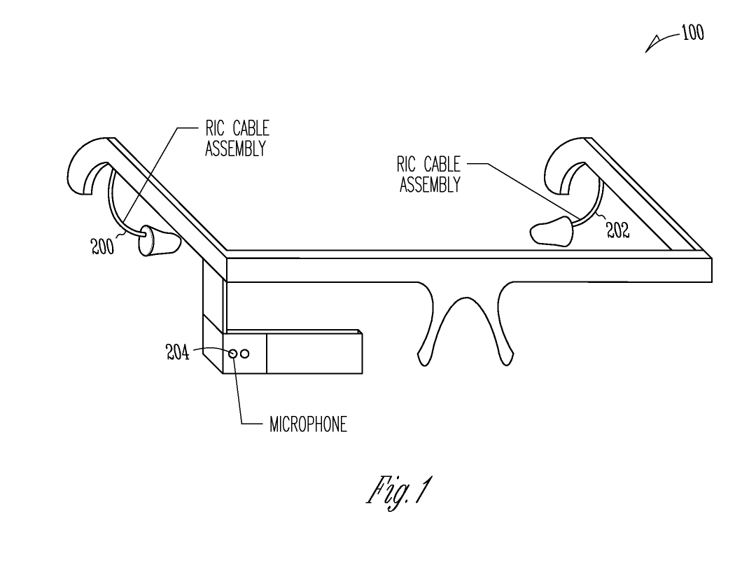

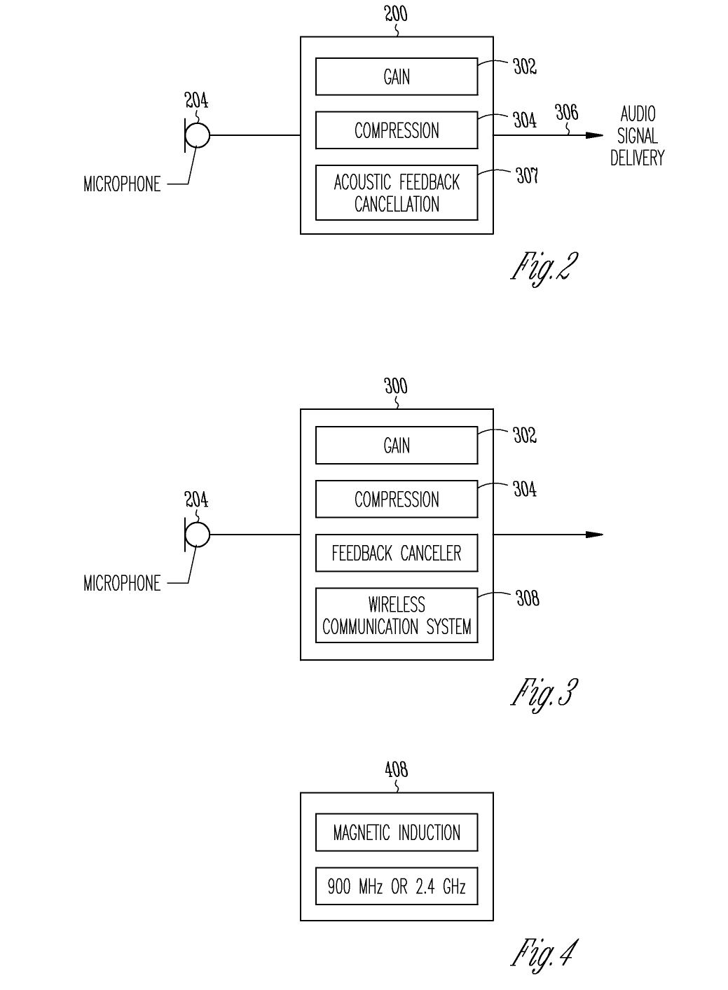

FIG. 1 illustrates a multisensory display device (MSD) 100 with a receiver-in-canal (RIC) hearing assistance device, according to various embodiments of the present subject matter. FIG. 2 illustrates a block diagram of a system including a hearing assistance device with cable assembly and an MSD, according to various embodiments of the present subject matter. The present subject matter relates to sound provided by such MSDs In various embodiments, receiver-in-canal hearing assistance device (RIC) cable assemblies 200, 202 are attached to an augmented reality multisensory display to provide audio delivery 306 with a speaker in the canal as an alternative to bone-conduction delivery or traditional earphone inserts. In various embodiments, MSDs are configured to monitor noise level in the environment and apply gain 302 and/or compression 304 to the audio from the augmented MSD to place spectral level of the MSD audio above the spectral level of the environmental noise, maintaining intelligibility and sound quality with changing environmental sounds.

In various embodiments, a microphone 204 is configured in the MSD such that sound from the environment is picked up, augmented in some way, and played to the MSD wearer. In this case, there may be feedback issues that require a feedback canceller 307—particularly if the MSD wearer has hearing loss and the audio augmentation includes amplification to correct for the hearing loss—which is not normally included in such systems.

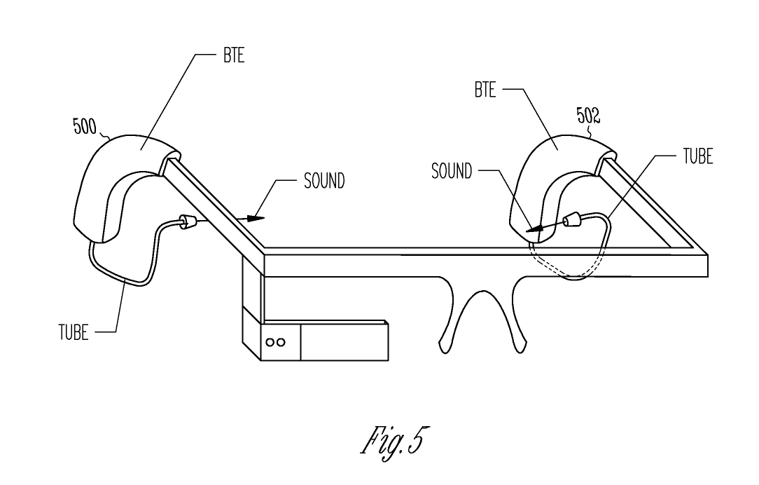

FIG. 3 illustrates a block diagram of a system including a wireless hearing assistance device 300 and an MSD, according to various embodiments of the present subject matter. FIG. 4 illustrates a block diagram of a wireless communication system 308 for the wireless hearing assistance device and MSD of FIG. 3, according to various embodiments of the present subject matter. In various embodiments, wireless in-the-canal devices 300 similar to wireless completely-in-the-canal (CIC) hearing aids or a wireless personal amplification device (or personal audio amplifier), such as an AMP device (www.starkey.com/hearingaids/technologies/Amp), are configured to pick up sound transmitted from the MSD for the sound delivery system to the MSD wearer. In various embodiments of communication system 408, the wireless transmission could be high frequency like 900 MHz or 2.4 GHz. In various embodiments, the wireless transmission may be near field magnetic induction, or may be electromagnetic signals such that a traditional telecoil or GMR transducer found in hearing aids can receive the transmitted audio from the MSD. In various embodiments, combinations of these systems may be employed and may be combined with other communication systems 308.

Some MSDs, such as GOOGLE GLASS, have bone conduction speakers/transducers to provide audio to the wearer of the MSD. There are many drawbacks to this, including poor sound quality due to the bandpass nature of sound conducted through the skull, and poor spatial perception due to distortion of binaural cues necessary for spatial hearing. In various embodiments, the MSD design is improved by combining the bone-conducted sound with delivery of air-conducted sound, such as the provided by a receiver in the wearer's canal that gets the audio signal from the MSD in a wired or wireless fashion. The air-conducted sound would enhance the sound quality and/or spatial character of the presented sound while maintaining the benefits of bone-conduction sound presentation, such as privacy of what is being heard. Since the air-conducted sound does not have to provide the full auditory experience, the levels and bandwidth of the air-conducted sound can be less than what they would have to be if there were no additional bone-conduction sound being provided.

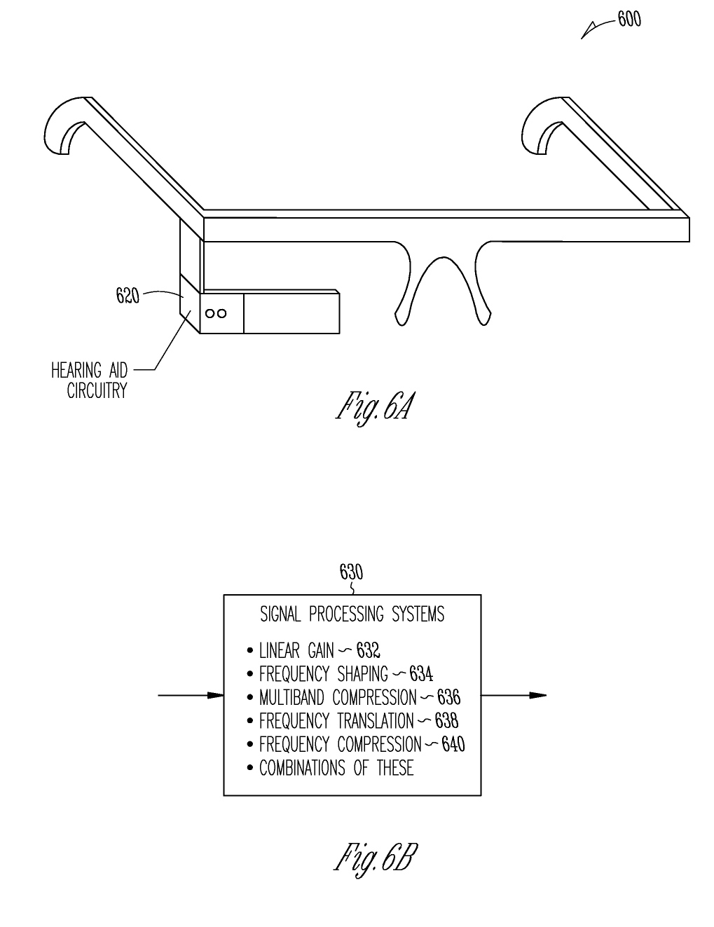

FIG. 5 illustrates an MSD with a behind-the-ear (BTE) hearing assistance device, according to various embodiments of the present subject matter. In various embodiments, BTE-style cases 500, 502 and hearing aid-type of electronics may be physically attached to the MSD so that the audio signal is electronically passed to the BTE device and the BTE device is responsible for providing delivery of sound to the wearer.

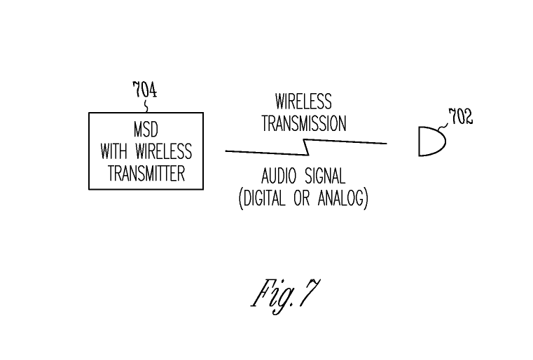

FIGS. 6A-6B illustrate an MSD with hearing aid circuitry, according to various embodiments of the present subject matter. In various embodiments, hearing aid circuitry 620 is embedded in the MSD 600 to provide audio that compensates for the hearing loss of the wearer, using such signal processing systems 630 as linear gain 632, frequency shaping 634, multiband compression 636, frequency translation 638, frequency compression, 640 and combinations of these.

FIG. 7 illustrates a wireless communication system for a wireless hearing assistance device and an MSD, according to various embodiments of the present subject matter. A deep-fitting device 702 that sits near the ear drum and can stay in a person's ear canal for weeks without removal and can be used as the sound delivery system for the MSD, where the MSD 704 transmits a digital or analog audio signal to the deep-fitting device wirelessly.

It is understood that variations in communications circuits, protocols, antenna configurations, and combinations of components may be employed without departing from the scope of the present subject matter. Hearing assistance devices typically include an enclosure or housing, a microphone, hearing assistance device electronics including processing electronics, and a speaker or receiver. It is understood that in various embodiments the receiver is optional. Antenna configurations may vary and may be included within an enclosure for the electronics or be external to an enclosure for the electronics. Thus, the examples set forth herein are intended to be demonstrative and not a limiting or exhaustive depiction of variations.

It is further understood that a variety of hearing assistance devices may be used without departing from the scope and the devices described herein are intended to demonstrate the subject matter, but not in a limited, exhaustive, or exclusive sense. It is also understood that the present subject matter can be used with devices designed for use in the right ear or the left ear or both ears of the wearer.

It is understood that hearing aids typically include a processor. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples may omit certain modules that perform frequency synthesis, frequency analysis, analog-to-digital conversion, digital-to-analog conversion, amplification, and certain types of filtering and processing. In various embodiments the processor is adapted to perform instructions stored in memory which may or may not be explicitly shown. Various types of memory may be used, including volatile and nonvolatile forms of memory. In various embodiments, instructions are performed by the processor to perform a number of signal processing tasks. In such embodiments, analog components may be in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

The present subject matter is demonstrated for hearing assistance devices, including hearing aids, including but not limited to, behind-the-ear (BTE), receiver-in-canal (RIC), and completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used with in-the-ear (ITE) and in-the-canal (ITC) devices. The present subject matter can also be used in hearing assistance devices generally, such as cochlear implant type hearing devices and such as deep insertion devices having a transducer, such as a receiver or microphone, whether custom fitted, standard, open fitted or occlusive fitted. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

What is claimed is:

1. A reality multisensory display device (MSD) to be used by a wearer having an ear, comprising:
a head-mounted display;
display circuitry configured to provide signals to the head-mounted display;
audio circuitry configured to augment audio delivered to the wearer; and
a receiver configured to be worn in the ear of the wearer and to play audio to the wearer.

2. The device of claim 1, further comprising:
a cable assembly configured to connect the receiver to the audio circuitry.

3. The device of claim 1, wherein the audio circuitry provides receiver-in-the-canal (RIC) processing for the audio played to be wearer by the receiver.

4. The device of claim 1, wherein the audio circuitry is configured to compensate for hearing loss of the wearer.

5. The device of claim 1, wherein the audio circuitry is configured to provide gain to the audio played to the wearer.

6. The device of claim 5, wherein the audio circuitry is configured to provide linear gain.

7. The device of claim 1, wherein the audio circuitry is configured to provide compression to the audio played to the wearer.

8. The device of claim 7, wherein the audio circuitry is configured to provide multiband compression.

9. The device of claim 7, wherein the audio circuitry is configured to provide frequency compression.

10. The device of claim 1, wherein the audio circuitry is configured to provide frequency shaping.

11. The device of claim 1, wherein the audio circuitry is configured to provide frequency translation.

12. The device of claim 1, wherein the audio circuitry includes an amplifier.

13. The device of claim 1, wherein the audio circuitry includes a feedback canceller.

14. The device of claim 1, wherein the audio circuitry includes a digital signal processor (DSP).

15. The device of claim 10, further comprising a microphone configured to sense acoustic signals and to communicate with the audio circuitry.

16. A reality multisensory display device (MSD) to be used by a wearer having an ear, comprising:
a head-mounted display;
display circuitry configured to provide signals to the head-mounted display;
audio circuitry configured to augment audio delivered to the wearer; and
a receiver configured to be worn on the ear of the wearer and to play audio to the wearer.

17. The device of claim 16, further comprising:
a cable assembly configured to connect the receiver to the audio circuitry.

18. The device of claim 16, wherein the audio circuitry is configured to compensate for hearing loss of the wearer.

19. The device of claim 16, further comprising a microphone configured to sense acoustic signals and to communicate with the audio circuitry.

20. The device of claim 16, wherein the receiver is included in a behind-the-ear (BTE) device.
